(19) United States
(12) Patent Application Publication
(10) Pub. No.: US 2014/0279871 A1
(43) Pub. Date: Sep. 18, 2014

(54) SYSTEM AND METHOD FOR PROVIDING NEAR REAL TIME DATA SYNCHRONIZATION

(71) Applicants: Marcelo Ochoa, Tandil (AR); Vanesa Dell'Acqua, Tandil (AR); Maximiliano Keen, Tandil (AR)

(72) Inventors: Marcelo Ochoa, Tandil (AR); Vanesa Dell'Acqua, Tandil (AR); Maximiliano Keen, Tandil (AR)

(21) Appl. No.: 13/802,502

(22) Filed: Mar. 13, 2013

(51) Int. Cl. G06F 17/30

(52) U.S. Cl. CPC G06F 17/30575
USPC 707/610

(57) ABSTRACT

A system and method enable the synchronization between a Relational Database Management System (RDBMS) and an external repository in Near Real Time (NRT) in an asynchronous mode. The external repository can be a data storage, as other database, where specific processes or tools (like Business Intelligence) run; or a set of tools to add to the database new features. For example, the system and method may be used to extend basic text search features provided by the database with the newest and complete Full Text Search (FTS) functionalities, such as faceting, geospatial, highlighting among others, natively into the SQL.

### FIELD

The disclosure relates to synchronize stored data in a standard Relational Database Management System (RDBMS) to an external repository in Near Real Time (NRT) in asynchronous mode.

### BACKGROUND

Traditional data synchronization for relational database management systems (RDBMS) works either in transactional mode or completely desynchronized. Traditional data synchronization causes a low Online Transaction Processing (OLTP) and index fragmentation on inverted index structure; on the other hand, decoupled architecture has the problem that changes on the RDBMS side are propagated too late for typical on-line applications. An example of the Index fragmentation caused by Oracle Text when working in transactional mode and the rate of DML changes is high. This makes index performance to degrade over the time and the only solution is to rebuild the entire index.

Solr Data Import Handler (DIH) uses the second approach. It has low performance for detecting high volume of changes when the crawler is trying to load a lot of changes. This is especially true if the application cannot adapt to include, for example, a column with a delta-change value.

### BRIEF DESCRIPTION OF THE DRAWINGS

FIG. 1 is a block diagram of a near real time data synchronization system;

FIG. 2 illustrates an example of a method for near real time data synchronization;

FIG. 3 illustrates an example of a near real time data synchronization for an insert command;

FIG. 4 illustrates an implementation of the near real time data synchronization system on one computer system;

FIG. 5 illustrates an implementation of the near real time data synchronization system with one computer system for each layer;

FIG. 6 illustrates an implementation of the near real time data synchronization system using a database management cluster system;

FIG. 7 illustrates an implementation of the near real time data synchronization system using database and external repository cluster;

FIG. 8 illustrates an example of a real time data synchronization for a delete command;

FIG. 9 illustrates an example of a near real time data synchronization delete command prior to commit;

FIG. 10 illustrates an example of a near real time data synchronization delete command with select after the commit; and

FIG. 11 illustrates an example of an Oracle database implementation of the system.

### DETAILED DESCRIPTION OF ONE OR MORE EMBODIMENTS

For purposes of the disclosure set forth below, the following references may be made:

[Oracle Text] - http://docs.oracle.com/cd/E11882_01/text.112/e24435/toc.htm
[Solr Data Import Handler (DIH)]- http://wiki.apache.org/solr/DataImportHandler
[Oracle Streams Advanced Queuing (AQ)] -
http://docs.oracle.com/cd/E11882_01/server.112/e25789/cmntopc.htm#CNCPT1715
[Hibernate Search]- http://www.hibernate.org/subprojects/search.html
[Oracle 11g EE] - http://www.oracle.com/technetwork/database/enterprise-
edition/index.html
[Scotas Push Connector]- http://www.scotas.com/download/scotas-
pushconnector-wp.pdf
[Solr]- http://lucene.apache.org/solr/
[ElasticSearch]- http://www.elasticsearch.org/
[Java in the Database] - http://www.oracle.com/technetwork/database/enterprise-
edition/index-097123.html
[Scotas OLS]- http://www.scotas.com/download/scotas-ols-wp.pdf
[ODCI]- http://docs.oracle.com/cd/E11882_01/appdev.112/e10765/toc.htm
[interMedia]- http://docs.oracle.com/cd/E11882_01/appdev.112/e10777/toc.htm
[RAC]- http://www.oracle.com/us/products/database/options/real-application-
clusters/overview/index.html
[TAF]-
http://docs.oracle.com/cd/E11882_01/network.112/e10836/concepts.htm#NETAG180
[PERSISTENT QUEUE]-
http://docs.oracle.com/cd/E11882_01/server.112/e17069/strms_glossary.htm#CBAEIBGJ
[TRANSACTIONAL QUEUE]-
http://docs.oracle.com/cd/E11882_01/server.112/e17069/strms_adqueue.htm#i1007037

The data synchronization system addresses the issues of traditional systems by adding an intermediate layer to keep changes to be applied into the external repository. The data synchronization system eliminates the slowdown of the OLTP transaction, index fragmentation and reduces the delay between the committed changes at the RDBMS layer and the visibility of the data into the external repository.

In the data synchronization system, the data in the external layer can be accessed directly by accessing the external repository, as well via the RDBMS layer through specialized operators and functions. These operators will work with a set of special keywords and syntax as input and returning a set of data matched.

In the data synchronization system, the data storage device, such as a database, notifies the system of any DML/DDL change on underlying tables, avoiding a full table scan in case of changes (insert/delete/update), batch process, triggers or delta-change detection. The system may be notified of each row change and the change synchronizes the external repository in near real time. The data storage system should have full ACID transaction support and also the queue used for keeping FIFO changes must be transactional.

FIG. 1 is a block diagram of a near real time data synchronization system 100. The system 100 may have three layers. Those layers may a LY01 that is a data storage layer that incorporates a data storage system, LY02 that is a queue and LY03 that is a data repository system and layer. The data storage layer may be implemented as a relational database management system (RBDMS) that has one or more computing devices 101 used by one or more users to connect to and interface/interact over a communication path with a RBDMS 102 that has one or more storage devices 102a. Each computing device 101 may be a processing unit based device that has sufficient wireless or wired connectivity, processing power and memory to be able to interact with the RBDMS 102, such as by sending SQL data manipulation language/data definition language (DML/DDL) requests and receiving SQL results when an SQL based database is used. For example, each computing device may be a desktop computer, laptop computer, smartphone device, tablet computer and the like, each with one or more processors, memory and connectivity circuits. In one implementation, each computing device may execute an application to interact with the RBDMS 102 or may execute a typical browser application. The communications path may be a wired or wireless path.

The RBDMS 102 may be implemented in a combination of hardware (cloud computing resources or one or more server computers) and software that operate like a typical RBDMS. In one embodiment, the data storage layer may be a typical relational database with ACID transaction support and a way to detect changes, including:
Notifications on DDL operations such as alter, rebuild, drop or truncate operations on the base table associated to the new index type
Notifications on DML changes, insert, update and delete row(s)
A unique row identity mechanism to identify a particular row that will not change over the time. Named RowId in this document.
Optionally a set of new operators and functions to interact with the external layer in SQL sentences.

The way to detect changes may be implemented as a piece of software in the RDBMS or in hardware in the RDBMS.

The queue layer may be a persistent transactional queue implementation that may have a first in first out (FIFO) structure for storing row changes. A transactional queue is a queue in which messages can be grouped into a set that is applied as one transaction. That is, a process performs a COMMIT after it applies all the messages in a group. Persistent means that the queue only stores messages on hard disk in a queue table, not in memory. In addition to the above functionalities, the queue implementation also may provide a listener or callback process which is automatically started when a commit operation is started that is consuming the messages in the queue. The listener or callback process may be implemented as a plurality of lines of computer code that may be executed by a process of a computer system that is used to implement the queue layer. The queue may store the index as one or more rows (similar to the data storage layer), but may also store the information about changes in the one or more rows of the data storage layer in various different data formats.

The data repository layer, LY03, may be a separated repository implementation. For example, this layer may be responsible for implementing an inverted index structure to provide Google Like search on inputs keywords and returning row-ID representing positive hits. Other examples of the implementation of the external repository may be NoSQL repositories or columnar optimized storages.

As shown in FIG. 1, when a change occurs in the data storage layer LY01, that layer may generate a put message that inserts a row change message into the queue. The queue may then pass the accumulated messages onto the external repository LY03 when a COMMIT is performed. The external repository and the data storage layer may then exchange queries and results between each other. The messages between layers could be implemented using HTTP, HTTPS or any other message system or protocol.

In the system, once a SQL sentence is interpreted by the RDBMS engine 102, several actions are started depending on whether the SQL sentence is a DML operation or a query. Specifically, when committing a DML operation, the changes may be propagated to the Queue. The external layer, running as separated server process, receives the row-ID(s) that was (were) changed updating its internal structure. In the system, only row-ID values are transmitted between processes, not the raw row data.

During SQL select operations, the RDBMS 102 communicates with the external repository instance using the Start-Fetch-Close semantic to send its query arguments to get the external data (sorts, etc). During a Fetch stage, it consumes rowid(s) that match with the query. At Close stage, the RDBMS cleans up every temporary structure.

The interaction among the layers in FIG. 1 are shown in FIG. 2 in more detail. FIG. 2 represents a general flow started for a DML statement, at time “t₀”. At “t₀”, a command (put (rowId, op) is issued by the change detector of the data storage layer to store the rowId and the sql action in the queue. After to until after t₄, the data storage layer and the external repository are out of sync (each has different data due to the sql action for the period indicated by the dotted box in the external repository portion of FIG. 2. At t₁, when a comit command is initiated by the data storage layer, a notify command is issued by the data storage layer (from the change detector) to the queue as shown. The queue then issues a callback command at time t₂ and the queue gets the row data from the data storage layer for the sql action (getRowData) and the data (data) may be returned to the queue at time t₃ from the data storage layer. The data may be then written into the external repository (a put(data) command) at time t₄. After the data is written into the external repository at time t₄, the data storage layer and the external repository are synchronized. Thus, when an SQL query at time t₅ is performed on the data storage layer, the data storage layer queries the external repository in time t₆ and get hits back that are returned to the user as results.

FIG. 3 extends the information of FIG. 2, in particular how the NRT affects SQL results through the time. At time “t₀”, the data storage layer makes a regular insert action, and also put the rowId and the sql action in the queue as in FIG. 2 above. From this point in time until after time t₈, the data storage layer and the external repository are out of sync since they contain different data due to the insert command. Thus, at time t₁, an sql query (SQL Query1) returns hits and results from the external repository at time t₂, but the data has not been synchronized.

The synchronization process starts at “t₃” by the commit command action. The commit command “wakes up” a callback job (at time “t₄”) that is responsible of synchronizing the data as was also described above. For each couple of rowId and sql action(s), this process looks at the data storage layer for the data (getRowData) to synchronize (“t₅”), and sends it to the external repository (“t₆”) using a put(data) command as shown. Even when a query is performed during the synchronization process (at time “t₇”), it results in a negative hit since the data is still not synched. A negative hit means that not exist data in the external repository LY3 that matches with the searched pattern, also when it is in the main repository LY1. However the sql result, Result2, may be are not empty, some other synchronized rows can match with the pattern. Immediately after this sync process finishes (at time “t8”), both systems are up to date, so the main transaction and other concurrent database connections get a positive hit (“t₉”) such as for SQL query SQLQuery3.

The data synchronization system with the three layers supports various different distributions of each of the layers/components among a set of resources, typically hardware such as is shown in FIGS. 4-7 and 11. Assuming that by itself, each component offers a mechanism to scale without affecting the performance, the data synchronization system provide a flexible way to configure different environment distributions.

FIG. 4 illustrates an implementation of the near real time data synchronization system on a computer system 400. In one implementation, the computer system may be a server computer or a cloud computing resource. As shown in FIG. 4, one or more applications, such as Application1, . . . , ApplicationN in FIG. 4, can read/write in the data storage layer LY01 and the data changes are available to read for the others in the external repository LY03 after the synchronization process. In the system in FIG. 4, the external repository LY03 can be accessed directly by the application, such as through a read port as shown. In the example in FIG. 4, the computer system may also have a read/write port that allows the one or more applications to interact with the data storage layer via especial sql operators.

FIG. 5 illustrates an implementation of the near real time data synchronization system 500 with one computer system for each layer LY01-LY03. In one implementation, each computer system may be a server computer or a cloud computing resource. As shown in FIG. 5, one or more applications, such as Application1, . . . , ApplicationN in FIG. 5, can read/write in the data storage layer LY01 and the data changes are available to read for the others in the external repository LY03 after the synchronization process. In the system in FIG. 5, the external repository LY03 can be accessed directly by the application, such as through a read port as shown. In the example in FIG. 5, the computer system may also have a read/write port that allows the one or more applications to interact with the data storage layer. Alternatively, since the load average on the computer system with the queue is very low, the queue and data storage layer may be both hosted on the same computer system.

FIG. 6 illustrates an implementation of the near real time data synchronization system 600 using a database management cluster system and FIG. 7 illustrates an implementation of the near real time data synchronization system 700 using database and external repository cluster. In this examples, more nodes/servers are added to the part of the system that really needs the computing power. For example, to improve the response time in the database, or to provide high-availability, a database cluster as shown in FIGS. 6 and 7 may be used. In the system in FIG. 7, there may also be an external repository cluster and the queue LY02 within the database cluster.

External Full Text Search Example

The system described above may be used, for example, for external full text search that is now described in more detail. The full text search (FTS) engine is a good example of the use of the system. In a typical relational database management system, the system provides some basic features to text search that are useful for general purposes. However, when users want to improve their applications with advanced FTS solutions, as “geospatial”, “highlight”, “more like this”, “did you mean” or others, they must look at external and specific solutions like, Lucene, Solr, ElasticSearch or other proprietary software. This kind of solutions requires an extra work to synchronize data between the RDBMS and the FTS engine. Different approaches exist to support it, but in general all of them make the synchronization process at application level. That means external batch process or extra code in the application logic to store and recover data in both systems. One improvement in this alternative is provided by some persistence frameworks, like Hibernate. It hides, for the point of view of the application, the extra logic to synchronize both systems. That is good for developers because they do not need to make big modifications into the application code. Unfortunately, it works fine for small projects, but working with big data the scalability must be taken into account, and some problems appear, like performance, synchronization among distributed data, database table partitions and FTS in a cloud.

The data synchronization system may be used to for this purpose, this process works at the storage level. From the point of view of the application (developers), operations such as insert, update and delete does not require extra code; to recover data, select statements must only use special operators in the where condition. In both cases, the RDBMS synchronizes and combines data from systems without affecting the performance in the main transaction.

The data synchronization system may be used to synchronize data between Oracle databases and Solr or Elasticsearch. This integration provides new domain index types, relational operators, several functions and procedures which can be used on SQL constructions or procedural code.

In one example of the use of the system, the data storage has a table called PRODUCTS that is full of records and the columns of this table are id, cat (for category), name, features, price, etc. The FTS engine is working and one implementation of the system is installed on the RDBMS, the system may create an index into the table and fields that the user wants to synchronize. The next exemplary SQL sentence is very similar to the regular way to create indices, except for a couple of parameters used by the system:

CREATE INDEX PRODUCTS_PIDX ON PRODUCTS(ID)INDEXTYPE IS PC.SOLR

PARAMETERS(′{Updater:″localhost@8983″,Searcher:″localhost@8983″,CommitOnSync:true,S
yncMode:OnLine,HighlightColumn:″name,features″,DefaultColumn:text,ExtraCols:″id\″id\″,cat
\″cat\″,name\″name\″,features\″features\″);

The first difference is the INDEXTYPE that data synchronization system uses (PC.SOLR in the example above). The PARAMETERS list can be adjusted for the particular data storage layer environment. In the example above, the Updater:“localhost@8983” and Searcher:“localhost@8983” point to the FTS engine. “ExtraCols:”id\“id”,cat\“cat\”,name\“name”,features\“features” . . . are the other columns that will be indexed too.

Running Queries:

Depending on the type of results desired by the user, there are different classes of SQL queries. It is very important to mention that all SQL queries interact with the FTS engine (external repository) to return the results. It is totally transparent from application point of view. For example, to search for all the documents which contain the text “video”, run query using the example code below:

Regular SQL Query:
SELECT name FROM PRODUCTS where name LIKE ‘% video %’;

FTS-SQL Query:
SELECT id FROM PRODUCTS where SCONTAINS(id,‘video’)>0

Regular SQL Execution Plan:

| | | | | | Cost |
|---|---|---|---|---|---|
| Id | Operation | Name | Rows | Bytes | (% CPU) |
| 0 | SELECT STATEMENT | | 1 | 13 | 3 (0) |
| 1* | TABLE ACCESS FULL | PRODUCTS | 1 | 13 | 3 (0) |

Predicate Information (identified by operation id): 1 - filter(““NAME”” LIKE ‘%video%’)

FTS-SQL Execution Plan:

| | | | | | Cost |
|---|---|---|---|---|---|
| Id | Operation | Name | Rows | Bytes | (% CPU) |
| 0 | SELECT STATEMENT | | 1 | 23 | 3 (0) |
| 1 | TABLE ACCESS BY INDEX ROWID | PRODUCTS | 1 | 23 | 3 (0) |
| 2* | DOMAIN INDEX | PRODUCTS_SIDX | | | |

Predicate Information (identified by operation id): 2 - access(““PC””.““SCONTAINS””(““NAME””,‘video’)>0)

The above execution plans shows how the RDBMS processes each sql query. The most important difference is the “TABLE ACCESS FULL” that means that this query always scan every row stored in the database looking for the word “video”. Working with big data, many millions of rows, it represents a long time to process it. On the other case, FTS-SQL query, the RDBMS detects a better structure to get the rowed that match with searched pattern. The “DOMAIN INDEX” is an inverted index, so is not necessary make a full scan over all rows in the database.

The below command get faceted results from FTS engine and there is a new function called facet( ) where the user needs to set the index name and the field you want to facet. For example:

Regular SQL Query:
SELECT cat, count(*) FROM PRODUCTS GROUP BY cat;

FTS-SQL Query:
SELECT SOLRPushConnector.facet(‘PRODUCTS_SIDX’, Null, ‘facet.field=cat_s’).fields.to_char( ) F FROM DUAL;

Regular SQL Execution Plan:

| Id | Operation | Name | Rows | Bytes | Cost (% CPU) |
|---|---|---|---|---|---|
| 0 | SELECT | | 3 | 24 | 4 (25) |
| | STATEMENT | | | | |
| 1 | HASH GROUP BY | | 3 | 24 | 4 (25) |
| 2* | TABLE ACCESS | PRODUCTS | 8 | 64 | 3 (0) |
| | FULL | | | | |

FTS-SQL Execution Plan:

| | | | | |
|---|---|---|---|---|
| Id | Operation | Name | Rows | Cost (% CPU) |

| | | | |
|---|---|---|---|
| 0 | SELECT STATEMENT | 1 | 2 (0) |
| 1 | FAST DUAL | 1 | 2 (0) |

The above execution plans show similar information as in the other plans. In this case not only exist a “TABLE ACCESS FULL”, also there is a “HASH GOUP BY”, and both represent a heavy processing. The RDBMS does not provide an efficient way to get facets. This feature is provided by the FTS engine (Solr), so through new operators, the RBDMS can make use of it to improve the time to process the query. That is shown in the row 1 of the FTS_SQL execution plan. Other option may be a combination of both examples, to get faceted results where the id contains the text “video”, run the code below:

Regular SQL Query:
SELECT cat, count(*) FROM PRODUCTS where name LIKE ‘% video %’
GROUP BY cat;

FTS-SQL Query:
SELECT SOLRPushConnector.facet(‘PRODUCTS_SIDX’,
‘name_t:video’,‘facet.field=cat_s’).fields.to_char( ) F FROM DUAL;

Regular SQL Execution Plan:

| Id | Operation | Name | Rows | Bytes | Cost (% CPU) |
|---|---|---|---|---|---|
| 0 | SELECT | | 1 | 21 | 4 (25) |
| | STATEMENT | | | | |
| 1 | HASH GROUP BY | | 1 | 21 | 4 (25) |
| 2* | TABLE ACCESS | PRODUCTS | 1 | 21 | 3 (0) |
| | FULL | | | | |

Predicate Information (identified by operation id): 2 - filter(““NAME”” LIKE ‘%video%’)

FTS-SQL Execution Plan:

| | | | | |
|---|---|---|---|---|
| Id | Operation | Name | Rows | Cost (% CPU) |

| | | | |
|---|---|---|---|
| 0 | SELECT STATEMENT | 1 | 2 (0) |
| 1 | FAST DUAL | 1 | 2 (0) |

This special query with a mix of facet and filtering are a good example to show the benefits for the RDBMS that represent a connection to other systems to improve its features. In this case, both query conditions are processed by the external repository and result of this works is joined with the data into the database to complete the fields asked in the query.

Other Full Text Search Features

Using the RDBMS API, new FTS features can be added as scontains and facets descripted above.

Example of a Possible Implementation: External Full Text Search with Security

The data synchronization system may also be implemented as OLS which is a tight integration of a popular, blazing fast open source enterprise search platform from the Apache Lucene project Solr with Oracle® 11g Enterprise Edition. The system provides to the Oracle RDBMS the power of the Solr searching facilities such as faceting, geospatial and highlighting among others natively into the SQL. Also by running Solr into the Oracle® RDBMS your SQL data is automatically indexed and updated in NRT (Near Real Time) way without any programming code.

The OLS implementation is specially designed for: applications requiring certification against security and audits standards, Advanced Full-Text Search features, Applications requiring no delay between data changes and a positive hit, Near Real Time update/insert and Real Time deletes, On-Line index/rebuild, Parallel index/rebuild. OLS is tightly integrated into the Oracle® RDBMS by using the Oracle® Data Cartridge API (ODCI) adding a new Domain Index the same way Oracle® Text or interMedia do. A domain index is like any other Oracle® index attached to some column of a specific table. This integration provides to Solr Engine with the ability of running as another Oracle® server process receiving notifications when rows are added, changed or deleted. Also, it is a bi-directional integration provisioning to the SQL a new relational operator (scontains) and several new functions and procedures which can be used on SQL constructions or procedural code. The OLS may replace the Lucene inverted index storage, which by default is stored on the OS file-system, by Oracle® Secure File BLOBs, resulting in high scalable, secure and transactional storage (performance comparison against NFS or ext3 file-system).

A summarizes advantages of this approach are:
Transactional storage, a parallel process can do insert or optimize operations and if they fail simply do a rollback and nothing happens to other concurrent sessions.
Compression and encryption using Secure File functionality, applicable to Lucene Inverted Index storage and Solr configuration files.
Shared storage for Lucene Inverted Index, on RAC installations several processes across nodes can use the storage transparently.

FIG. 11 illustrates an example of an Oracle database implementation of the system and shows how many processes interact during OLS operation in an Oracle® RAC installation. External applications connect to the Oracle instance using transparent fail-over configuration (TAF) which routes the SQL sentences to some of the nodes of the installation. Each connection to the RDBMS has associated an Oracle® process ora_d00n if it is connected using a dedicated connection or an ora_s00n if it is configured in shared mode. A parallel slave server process which is started during database startup runs a Solr server instance for one or all OLS index declared. The communication between this Solr instance and the client process which is associated to the client connection is using HTTP binary format.

Once a SQL query is interpreted by the engine several actions are started depending on if it is a DML operation or a query. For DML operation once it is committed, the changes are propagated by the Oracle® AQ sub-system and the Solr instance, running as separated server processes, receives the rowId(s) that was (were) changed updating its index structure. Only rowId values are transmitted between processes, not the row data. Solr receives the rowId that needs to be updated and if it is necessary gets the row values from the table(s) involved (these are processed using the internal OJVM drivers which have directly access to SGA areas of the RDBMS).

During SQL select operations the client associated process (ora_d00n or ora_s00n) talks to the Solr server instance using the start-fetch-close semantic, sending Solr query arguments (sorts, etc). During fetch stage, consuming rowId(s) that match in the fetch stage and cleaning up every temporary structure at close stage.

While the foregoing has been with reference to a particular embodiment of the invention, it will be appreciated by those skilled in the art that changes in this embodiment may be made without departing from the principles and spirit of the disclosure, the scope of which is defined by the appended claims.

1. A system for data synchronization, comprising:
a data storage component having a relational database hosted on a computer with ACID transaction support that stores data in one or more rows, the data storage component having a change detector that detects changes in the one or more rows;
a separate layer hosted on a computer having a queue, coupled to the data storage component, having one or more elements wherein each element stores only a row identifier that identifies the row that changed and an operation that caused the row to change for each row that changed in the data storage component based on a notifier message from the change detector, the one or more elements of the queue being used to update a repository; and
a separate layer hosted on a computer having the repository that is different than the relational database, coupled to the data storage component and the queue, that stores an index of the data in the one or more rows of the data storage component, wherein the repository is updated with the changes to the one or more rows in the data storage component using the one or more elements from the queue when a commit operation is performed in the data storage component.

2. (canceled)

3. The system of claim 1, wherein the queue retrieves the data for the changed row from the data storage component and sends the data from the changed row to the repository to update the repository.

4. The system of claim 3, wherein the queue has a callback job, that is initiated by the commit operation, to update the repository.

5. The system of claim 1, wherein the data storage component, queue and repository are hosted on a single computer system.

6. The system of claim 5, wherein the single computer system is a server computer.

7. The system of claim 1, wherein the data storage component, queue and repository are each hosted on a separate computer system.

8. The system of claim 1, wherein the data storage component is hosted on a cluster and the queue and repository are each hosted on a separate computer system.

9. The system of claim 1, wherein the data storage component and queue are hosted on a cluster and the repository is hosted on a separate computer system.

10. The system of claim 1, wherein an SQL query to the data storage component causes a query to the repository to perform a search based on the index.

11. A method for data synchronization, comprising:
storing, on a data storage component having a relational database hosted on a server with ACID transaction support, data in one or more rows;
detecting, by the data storage component, changes in the one or more rows in the data storage component;
storing, in a queue hosted on a server in a separate layer that is coupled to the data storage component, a change in one or more elements to the one or more rows in the data storage component based on a notifier message, wherein each element stores only a row identifier that identifies the row that changed and an operation that caused the row to change, the one or more elements of the queue being used to update a repository; and
storing, in the repository that is different than the relational database hosted on a server in a separate layer that is coupled to the data storage component and the queue, an index of the data in the one or more rows in the data storage component; and
updating the repository with the changes to the one or more rows in the data storage component using the one or more elements of the queue when a commit operation is performed in the data storage component.

12. (canceled)

13. The method of claim 11, wherein updating the repository further comprises retrieving, by the queue, the data for the changed row from the data storage component and sending the data from the changed row to the repository to update the repository.

14. The method of claim 13, wherein the queue has a callback job, that is initiated by the commit operation, that updates the repository.

15. The method of claim 11 further comprising receiving, by the data storage component, an SQL query, generating, by the data storage component, a query to the repository and performing, at the repository based on the query, a search based on the index.
